(19) United States
(12) Patent Application Publication
(10) Pub. No.: US 2015/0379597 A1
(43) Pub. Date: Dec. 31, 2015

(54) NETWORKED BIDDING TRANSACTIONS

(71) Applicant: Relovate, Inc., Mount Arlington, NJ (US)

(72) Inventors: Shaleen Gupta, Mount Arlington, NJ (US); Raghu Gopalakrishnan, Hopatcong, NJ (US); Charles Saldarini, Mahwah, NJ (US); Keith Bertenshaw, Rockaway, NJ (US); Linwood Perry, Chester, NJ (US)

(21) Appl. No.: 14/736,379

(22) Filed: Jun. 11, 2015

Related U.S. Application Data
(60) Provisional application No. 62/016,782, filed on Jun. 25, 2014.

(51) Int. Cl. G06Q 30/06

(52) U.S. Cl. CPC G06Q 30/0605

(57) ABSTRACT

Systems and methods here may be used for conducting computer network transactions, via at a server computer in communication with a network and a database. Such examples may include receiving merchant information from merchant/bidders, categorizing the received merchant information, storing the merchant information and the associated category in the database, receiving a need from a user/buyer computer, identifying a category that the received need fits into based on the categories of merchant information, posting the received need information so the merchants identified for that category may access the posted need information and allowing the merchant/bidders to bid on the received need.

### TECHNICAL FIELD

This application relates to the field of computer systems, specifically, computer systems for networked bidding transactions.

### BACKGROUND

Previously, in order to buy items or services online, a user buyer would log onto the internet and navigate to a merchant's website. There, the user buyer could select an item for purchase, from the merchant's site. Different ways of online/networked transactions could be beneficial for both buyers and merchants.

### SUMMARY

Systems and/or methods here include embodiments for conducting computer network transactions, including at a server computer in communication with a network and a database, receiving merchant information from merchant/bidders via the network, categorizing the received merchant information, storing the merchant information and the associated category in the database, receiving a need from a user/buyer computer via the network, identifying a category that the received need fits into based on the categories of merchant information, if the received need matches a merchant category, posting the received need information so the merchants identified for that category may access the posted need information, if the received need does not match a merchant category, requesting more information from the user/buyer via the network until a category is matched, and posting the received need information so the merchant/bidders identified for that category may access the posted need information, allowing the merchant/bidders to bid on the received need, receiving bids from the merchant/bidders on the received need, submitting the received bids from the merchant/bidders to the user/buyer, receiving from the user/buyer a selection of a submitted bid from the merchant/bidders, removing the posted received need information implying bidding is closed, so no more merchant/bidders may access the information and submit bids.

In certain examples, the receiving confirmation from the user/buyer of a selection of a submitted bid from the merchant/bidders is via an arranged set of acceptance criteria sent by the user/buyer and stored by the server computer in the database.

Certain examples have a micro market system interface which allows the merchant/bidders to review submitted need information via the network. Alternatively or additionally, examples include notifying the merchant/bidders of received needs that match the stored received merchant information category.

In some examples, if the received need does not match a merchant category, creating a new category and posting the received need information so the merchants identified for that new category may access the posted need information; and in some other examples, the allowing the merchant/bidders to bid on the received need, and the receiving bids from the merchant/bidders on the received need, are time limited by the system. In certain examples, the receiving merchant information from merchant/bidders via the network further includes receiving an indication of a category from the merchant/bidder via the network.

Alternatively or additionally, in some examples, the identifying a category that the received need fits into based on the categories of merchant information includes receiving an indication of a category from the user/buyer via the network; and some, further comprise after submitting the received bids from the merchant/bidders to the user/buyer, if no confirmation from the user/buyer of a selection of a submitted bid from the merchant/bidders is received, re-posting the received need information so the merchants identified for that category may access and review the posted need information. Some examples include receiving, from the user/buyer via the network, a rating of the merchant/bidder selected by the user/buyer, and posting the rating of the merchant/bidder via the network so other user/buyers may view the rating of the selected merchant/bidder.

Certain example embodiments may include systems and/or methods for conducting computer network transactions, including a server computer in communication with a network and a database, the server computer configured to receive merchant information from merchant/bidders via the network, categorize the received merchant information, store the merchant information and the associated category in the database, receive a need from a user/buyer computer via the network, identify a category that the received need fits into based on the categories of merchant information, if the received need matches a merchant category, post the received need information so the merchants identified for that category may access the posted need information, if the received need does not match a merchant category, request more information from the user/buyer via the network until a category is matched, and post the received need information so the merchant/bidders identified for that category may access the posted need information, allow the merchant/bidders to bid on the received need, receive bids from the merchant/bidders on the received need, submit the received bids from the merchant/bidders to the user/buyer, receive from the user/buyer a selection of a submitted bid from the merchant/bidders, remove the posted received need information implying bidding is closed, so no more merchant/bidders may access the information and submit bids.

Examples may also include instances where the receive confirmation from the user/buyer of a selection of a submitted bid from the merchant/bidders is via an arranged set of acceptance criteria sent by the user/buyer and stored by the server computer in the database; and some examples may include a micro market system interface which allows the merchant/bidders to review submitted need information via the network. In certain examples, the server computer is further configured to notify the merchant/bidders of received needs that match the stored received merchant information category.

Some examples include embodiments where the received need does not match a merchant category in which the system may create a new category and post the received need information so the merchants identified for that category may access the posted need information. In other embodiments, allowing the merchant/bidders to bid on the received need and the receive bids from the merchant/bidders on the received need may be time limited by the system.

In certain other examples, the receiving merchant information from merchant/bidders via the network further includes receiving an indication of a category from the merchant/bidder via the network. And in some examples, the server computer may be further configured to receive from the user/buyer via the network a rating of the merchant/bidder selected by the user/buyer, and post the rating of the merchant/bidder via the network so other user/buyers may view the rating of the selected merchant/bidder.

Certain examples may be for conducting computer network transactions, including at a server computer in communication with a network and a database, receiving merchant information via the network, storing the merchant information and the associated category in the database, receiving a need from a user/buyer computer via the network, posting the received need information so the merchants may access the posted need information, allowing the merchants to bid on the received need, receiving bids from the merchants on the received need, submitting the received bids from the merchants to the user/buyer, and receiving a selection of a submitted bid from the merchant/bidders. And in some examples, the receiving, from the user/buyer via the network, a rating of the merchant/bidder selected by the user/buyer, and posting the rating of the merchant/bidder via the network so other user/buyers may view the rating of the selected merchant/bidder.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1 shows an example wireless network system according to some embodiments here.

FIG. 2 shows an example flow chart according to some embodiments here.

FIG. 3 is another flow chart example according to some embodiments here.

FIG. 4 is another flow chart example according to some embodiments here.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without all of these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

### Overview

The current paradigm of online stores/websites is set up so that the user may visit a specific website on the internet in order to purchase an item or service. This constant stream of users to various sites can create a captive audience which companies use to target advertisements. Targeted advertisements may even be based on previous activity by a particular user or based on preferences that the user has indicated somewhere. Sometimes cookies or other tracking devices are used to determine user preferences based on web browsing history.

This paradigm can keep companies focused on targeted advertising, as well as finding and selling user preference data instead of focusing on a user individually. As a result, existing methodologies are focused on a user searching for a product or service, and then going to multiple websites to explore buying options, to subsequently making a decision about the purchase.

In this disclosure, systems and methods are described for different ways to fulfill a user's or a group of users' needs. Certain embodiments here may eliminate or minimize the need for advertising on individual websites. This could also reduce or eliminate targeted email/message or “spam” advertising. Such changes could add to the desirability of the embodiments because a particular user may not be subjected to a bombardment of advertising, or have to use cookies while browsing.

Certain embodiments here may allow users to go to a private portal on a network such as the Internet or World Wide Web, where the user can describe a particular need. Examples of needs could be anything from a product such as a car, television, computer, new deck on the house, to a service such as a delivery, transportation across town, or across the globe. Any manner of need could be described. The system could then take that described need, mask the identity of the requesting user, and make the need available in an online marketplace. In such a marketplace, working in reverse from a typical one, merchants would be the ones who would view the users' needs and bid on them. In such a way, the reverse marketplace would have the merchants attending a consolidated user need market instead of the user/buyer attending a market filled with merchants selling things.

Such an arrangement may allow the user/buyers to retain their privacy in searching out merchants to purchase goods/services from. If and when the user/buyer chooses to make a purchase, specific information regarding the funds, the shipping, identify if needed, etc., may be revealed to the merchant when necessary.

Additionally, such arrangements may allow for the system to not generate or store cookies of any sort. The system could be configured to retain private information, and the system administrators could refuse to sell customer information to advertisers and marketers. These and other features of the systems and methods described herein avoid the need of a user to access and search through multiple websites. In addition, the systems and methods of the present disclosure avoid the need to generate and store cookies, and they also reduce or eliminate targeted email/message or “spam” advertising. As such, the present disclosure improves the efficiency, memory, processing and other operational elements of the users' and merchants' computer components.

As an example, such a system could be used to plan a trip to NYC with two nights' stay at a hotel this weekend. The system could have the ability to look for available hotels, show results to a potential customer online, facilitate booking a hotel room with a garden view, book a spa treatment, book a tennis court, etc. Such an example system could remember user preferences such as (for example): “You like to use the spa, you like a garden view, you like tennis, etc.” Then, the system could match your preferences to vendors who can fulfill those needs, and expose those customers within the relevant marketplace. This could then allow relevant, targeted merchant/sellers to then bid on the customer/user. There could be an active bidding process, or a static pre-arranged deal that is pushed to a user for selection.

Thus, the systems and methods herein could provide a private user interface, without polluting it with spam ads and/or browser cookies. Such processes may help the computer process to flow with fewer executable commands. Such a process may help streamline the user/merchant interactions because it may result the technical effect of avoiding the sale of data, the reduction of spam ads sent, and the reduction of pop-up ads on a browser window as well.

The systems and methods disclosed herein could then be used to receive many multiple needs at the same time or in close proximity, classify them and post them for relevant merchants. Such computations of aggregating and analyzing could be sent around the globe to user/buyers and merchant/bidders who merely have an internet connection. The back end systems, for example, may quickly take bids and determinations on bids from these many multiple user/buyers and merchant/bidders. The systems and methods here provide for a private website interface which does not allow advertising or spam, and does not allow selling of users' data. User/buyers may activate bids from the online marketplace, at his/her own choosing. There may be multiple levels of “bidding” which may be offered based on its agreements with its service providers.

### Example Networks

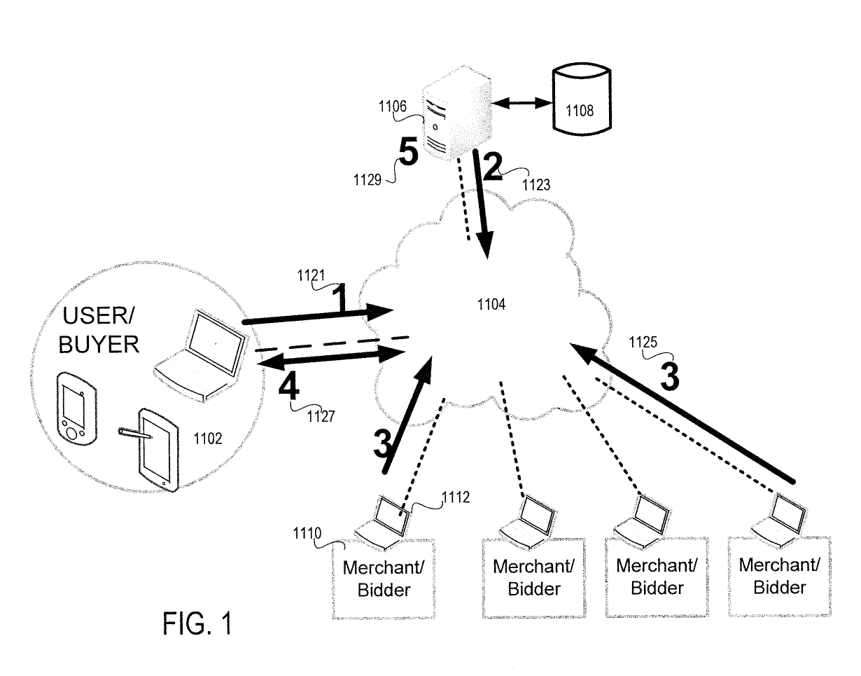

Such systems and methods described herein may be completed and carried out over any of various computer networks including the Internet and/or World Wide Web. FIG. 1 shows an example of a wireless network which could support such communications and arrangements, as well as steps which could be taken to carry out certain embodiments. For example, any of various user devices 1102 which are individually capable of communication over a land line, a wireless such as a WiFi, femtocell, pico cell, 3G or LTE cellular or any other kind of network may access the Internet 1104. These devices could be anything from a server such as a network server, a processor, a microprocessor, a personal computer (PC), a laptop computer, a palm PC, a desktop computer, a workstation computer, a tablet, mainframe computer, an electronic wired or wireless communications device such as a telephone, a cellular telephone, a smartphone, a tablet, a phablet, a personal digital assistant, a voice over Internet protocol (VOIP) phone, an interactive television, an electronic pager, a car, a smart watch, smart glasses, etc. Any device capable of accessing and interfacing with the Internet or a voice recognition system through a cellular or telephone line could be used to access these systems and methods here.

The system could have a back end server 1106, database 1108 and administrator interface (not shown) also in communication with the Internet 1104. In certain examples, the database 1108 could be a cloud based or decentralized database (not pictured).

The merchant/bidders 1110 could each have their own computer(s) or communication device(s) 1112 in communication with the internet 1104. It should be noted that the access points, the land lines, the Internet servers, etc. are not depicted in FIG. 1. Such communication elements may allow the individual computers to communicate over the network 1104.

In addition to the network architecture in FIG. 1, a series of steps are laid out as well. In certain example embodiments, first, 1121 the user/buyer 1102 could post their need on the system 1106 via the internet 1104. Then 1123 the system 1106 could store the need information in the database 1108 and compare the need information with a product or service and post that to the merchant/bidders 1110 via the internet 1104. Then 1125 the merchant/bidders 1110 could view the need information and make bids via the internet 1104.

The user/buyer 1102 could then accept 1127 a bid or reject all bids via the Internet 1104. At this time 1129, the system 1106 may then make a determination to complete the transaction with the winning merchant/bidder 1110 or start the process over if no bids were accepted. All of these example embodiment steps above may take place via various networks and computers as described here.

It should also be noted that a time element may be used in certain examples. Such a time limited example may open a window of time for which to accept bids from merchant/bidders 1110, thereby giving a deadline for the user/buyer 1102 to decide which bid(s) to accept.

### User/Buyer Product or Service Selection Interfaces

As described above in FIG. 1, the systems and methods herein can be practiced via a networked group of computers. This may be via computers which have access to the Internet from anywhere in the world. Such systems and methods could allow these networked users to interact via a centralized website. In certain example embodiments, a graphical user interface to such centralized website would allow users/buyers and merchants/bidders to log into the system and post needs, place bids, research user/buyers, research merchant/bidders, or any number of other things.

Thus, certain example embodiments may include a user interface with multiple parts: a user/buyer interface and a merchant/bidder interface, each tailored to the individual needs of the respective groups, as well as other optional interfaces tailored to special needs. The navigation of the system into the different parts: user/buyer and merchant/bidder could be via different websites, or one website with choices on which side to log into. Any number of logins with usernames and passwords, depending on the registration, discussed below, of the user/buyer and merchant/bidder could be used.

The visual layout of such an interface, on a web browser could take many forms. The graphical user interface (GUI) could appear like a brick and mortar store, mimicking the experience at a physical store. The interface could be minimal and include text descriptions or photos and/or drawings of the items and services submitted. Any kind of interface that would allow the merchant/bidders to quickly and easily access their target audience would be helpful for the merchants and users alike who could find their match more easily.

In certain example embodiments, the user/buyer interface could include any number of features that would aid the user/buyer in getting their submission properly posted and also properly described. The interface could include suggestions of popular or successful offers that other users have submitted in the past. User/buyers could even populate their submissions with product information. Such information could help the merchant/bidders to narrow in on their targets and accurately bid on user submissions. Such information could be obtained from manufacturer catalogs, Universal Product Code (UPC) and International Article Number (EAN) databases, online retailers and other sources or partners.

User/buyers could register with the system in order to inform the system of certain things and help vet them for financial risk. In certain embodiments, a user/buyer could register with the system in order to obtain a username and password to log into the system, access financial accounts, help the system keep track of user actions, identify the geographic location for delivery and availability purposes, etc. Any number of different things could be asked of the user/buyer upon registering including financial history, credit score, etc. As the user/buyers, in certain embodiments, would be promising to pay a merchant/bidder who wins the bid, the system may be configured to remove those user/buyers that do not fulfill their financial obligations. The system may be configured to categorize user/buyers by credit score so merchant/bidders are more informed about the risk of committing to a particular user/buyer. Any amount of data could be collected here and used to help the markets.

A user/buyer may also want to register not only an account with the system, but eventually, the needs they wish to be fulfilled. Examples of what a needs registration could include could be a brief description of the service or product sought, a detailed description of the service or product sought, location where the service may be sought, Uniform Resource Locators (URLs) or links to websites with descriptions or pointers to specific things, key tags that may be relevant to the need request, images or media to describe the service or product requested. The better the user/buyer describes the need, the more likely that a merchant/bidder will understand that need and bid to fulfill that need accurately.

### Merchant/Bidder Product or Service Selection Interfaces

Just as an interface could be tailored for a user/buyer, it could also be tailored for a merchant/bidder. In certain examples, when a login occurs, some kind of identification allows the system to present the appropriate interface: user/buyer or merchant/bidder. In certain example embodiments, where a merchant/bidder logs in, the system may present an interface that allows the merchant/bidders to register their service or products on the website.

The merchant/bidder interface may include product and/or service selections that enable merchant/bidders to search for, compare and contrast, as well as create and refine a collection of products or services on offer at the website. The merchant/bidder interface could allow the merchant/bidders to narrow in on and identify the user/buyers who have submitted needs that the particular merchant/bidder can fulfill. In an example, a merchant/bidder who sells bicycles may not be interested in wading through submissions for user/buyers that are looking to buy airplane tickets. Instead, the system could have individualized market places (and/or market place filters) that focus on a particular good and/or service (or a particular group of goods and/or services). Through such an example system, the merchant/bidders could narrow in on their target user/buyers, in a micro-market example as described below.

Just as user/buyers could register with the system, so too may merchant/bidders. In such a way, the merchant/bidders could inform the system of their products, services, and location so as to enable the system to best match the need requests with the merchant/bidders. In this way, the system can be better informed and allow for better and more accurate bids to be placed.

### Micro-Markets Examples

Certain example embodiments may include a Micro-market functionality. Such Micro-Market functionality could allow a merchant/bidder to send multiple bids to multiple users at various times. In such a way, a mass marketer could cover many multiple user/buyer bid posts at the same time or close in time. Again, merchant/bidders could arrange to configure such settings into the system, depending on their ability to meet demand. For example, if a mass distributor of tires has five hundred sets of tires in stock, it could configure the system to bid on up to five hundred user/buyer need posts. If the system found that some of those user/buyer need posts were fulfilled or won by other bidders, the system could then seek out other user/buyers to bid by knowing that the stock of five hundred wasn't depleted by the losing bid. This example is not intended to be limiting and any number of bids could be programmed.

Certain example embodiments may allow groups of user/buyers to compile their need posts so as to appear as a bulk purchase request to a merchant/bidder. In such a way, if multiple user/buyers post a bid request for the same item(s) or service(s), the system could group them together and merchant/bidders could bid on the lot as a group instead of individually. Such a grouping could allow for merchants to discount their product or service more sharply in order to receive a larger order.

Such a system could be automatically set to accept a certain offer by the group, or it could require each user/buyer to accept the offer one by one. A time period could also be arranged so that the best bid within a certain amount of time was accepted. This time could be invisible to the merchant/bidders so as to protect against last second bids, or the time could be visible to the merchant/bidders to drive competition.

Once bids are accepted by the user(s), the micro-market can close. The lifetime of different micro-markets and the bids associated with them could be variable depending on the nature of the products or services being sought and the attributes associated therewith.

### Example Micro Market Process

In certain example embodiments, as described above, a micro market may be established by the system. Such micro market could be used to specialize the website interface for the user/buyers and/or the merchant/bidders. Such specialized micro markets may cater specifically to the individualized products or services being requested and bid upon. This could allow the system to customize the online marketplaces, and also to pay special attention to high value markets. For example, if the smartphone marketplace is one which generates a lot of business, an individualized smartphone micro market could be created with shortcuts that could allow user/buyers to customize their need requests. It could facilitate the ability of merchant/bidders in the smartphone industry to offer bundled packages, timely deals and sales of different varieties.

Another example regarding a micro market could be the system pushing pre-arranged deals when user/buyers post needs. In such an example, within a micro market, there may already be a certain brand of hotels listed (e.g., Hilton hotels). If a user meets certain criteria, the system could push a deal to the user, as a static bid arrangement. Such an example would be different from real time bidding or could be used in conjunction with a real-time bidding scenario. Further, there could be multiple levels of criteria. There could also be groups that users/buyers belong to that fulfill the criteria to receive deals.

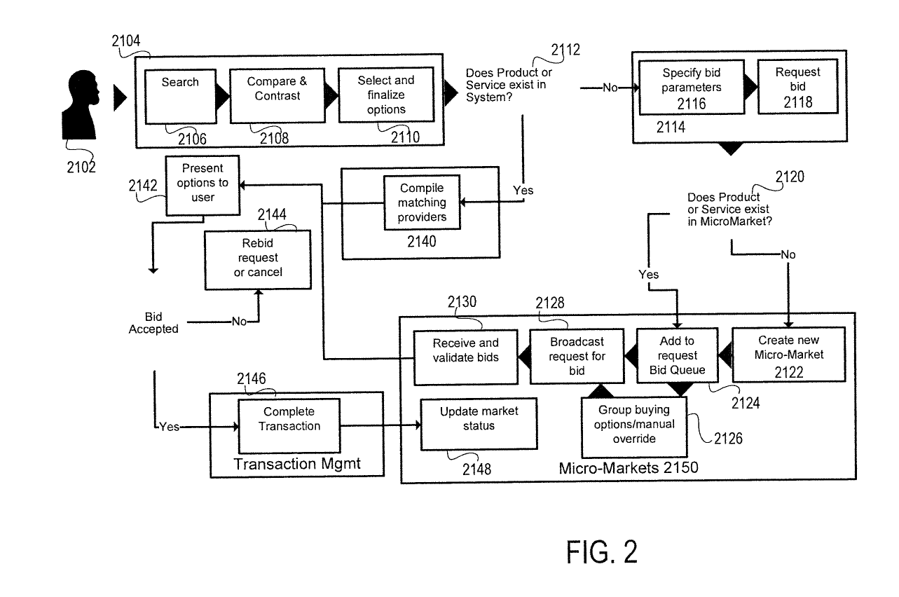

FIG. 2 is an example flow chart that shows the steps of an exemplary process flow consistent with certain example embodiments herein. In FIG. 2, the user/buyer 2102: Conducts a Product or Service Selection 2104 by first inputting a search 2106, the system then compares and contrasts 2108 and finally the user selects and finalizes options 2110.

Next, the system checks if the input product or service exists in the system 2112. If no (i.e., the product or service does not exist in the system), the system conducts a Bid Prep 2114. Bid Prep 2114 may include specifying bid parameters 2116 and Requesting a Bid 2118.

Next, the system determines if the product or service exists in an existing Micro Market 2120. If it does not, the system may create a new Micro Market 2122. If yes (i.e., the service or product does exist in a Micro Market), or if a new Micro Market is created, the system may add the request to a Bid Queue 2124. A Group Buying option or manual override 2126 may next take place before the system broadcasts the request for bid 2128. Then the system may receive and validate bids 2130.

If the product or services does exist in the system 2112, then the system may compile matching providers 2140.

From here, the system may present options to user/bidders 2142 from either the compiled matching providers 2140 or the received and validated bids 2130.

If the bid is not accepted, the system can create a rebid request or cancel the transaction 2144.

If the bid is accepted 2146, the transaction management system can complete the transaction 2146 and update the market status 2148 in the micro market 2150.

Another aspect of the example of FIG. 2 could be a database check to select what is relevant. In such an example, the system could run a relevance check to see what should be pushed and present options in real time via a network. These could be sent to a supplier. Further, Bid Prep could exist in multimedia. FIG. 2 shows a broadcast bid in multimedia and/or social media with the results sent back to the user/buyer.

### Example Overview Process

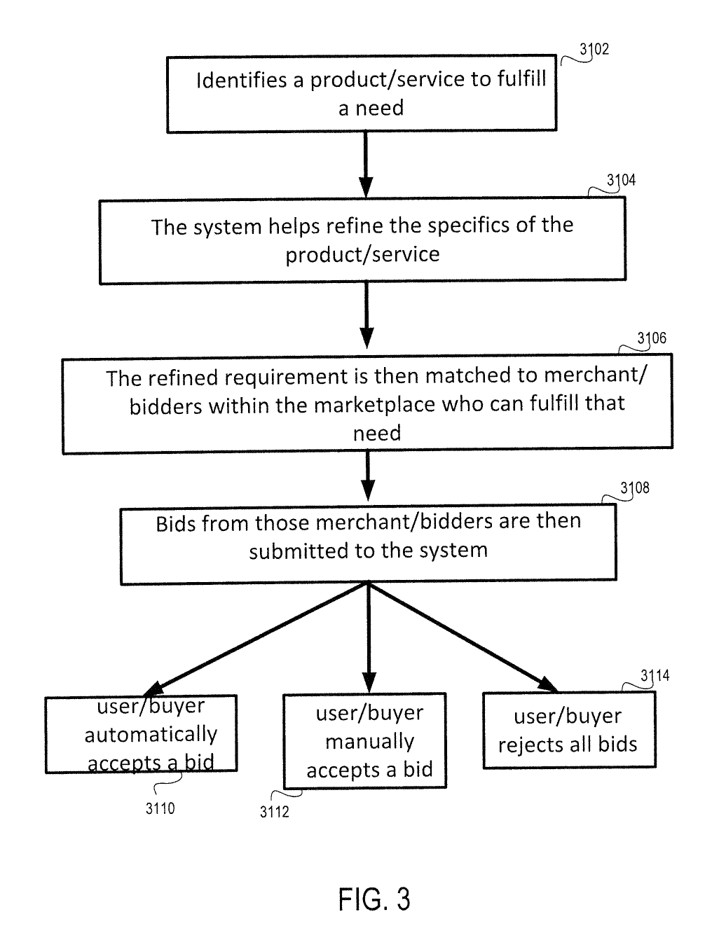

The processes described above regarding the transactions can also be thought of in an overview style flow chart. FIG. 3 is an example diagram that provides an overview of an exemplary process flow consistent with certain example embodiments. In FIG. 3, the user/buyer:

First identifies a product/service to fulfill a need 3102;

Then the system helps refine the specifics of the product/service 3104;

Next, the refined requirement may then be compared and matched to merchant/bidders within the marketplace who can fulfill that need 3106; and

Bids from those merchant/bidders may then be submitted to the system 3108;

Then the user/buyer may automatically accept a bid 3110; or

Then the user/buyer may manually accept a bid 3112; or

Then the user/buyer rejects all bids 3114.

In such a way, the system can intake need requests from user/buyers and facilitate bids from merchant/bidders by helping the user/buyers first properly describe their need, and next, match that need to merchant/bidders who can best fulfill that need, all while avoiding the user/buyers having to subject their computing/communication devices to unwanted cookies, advertisements, spam, etc., thereby conserving user computing resources.

In certain example embodiments, the system can learn user habits, based on stored information about previous transactions, or even by querying users for answers to particular questions. In such example embodiments, the system could then deliver customized interfaces, customized prompts and preferences for individual user accounts.

### Another Example Process Flow:

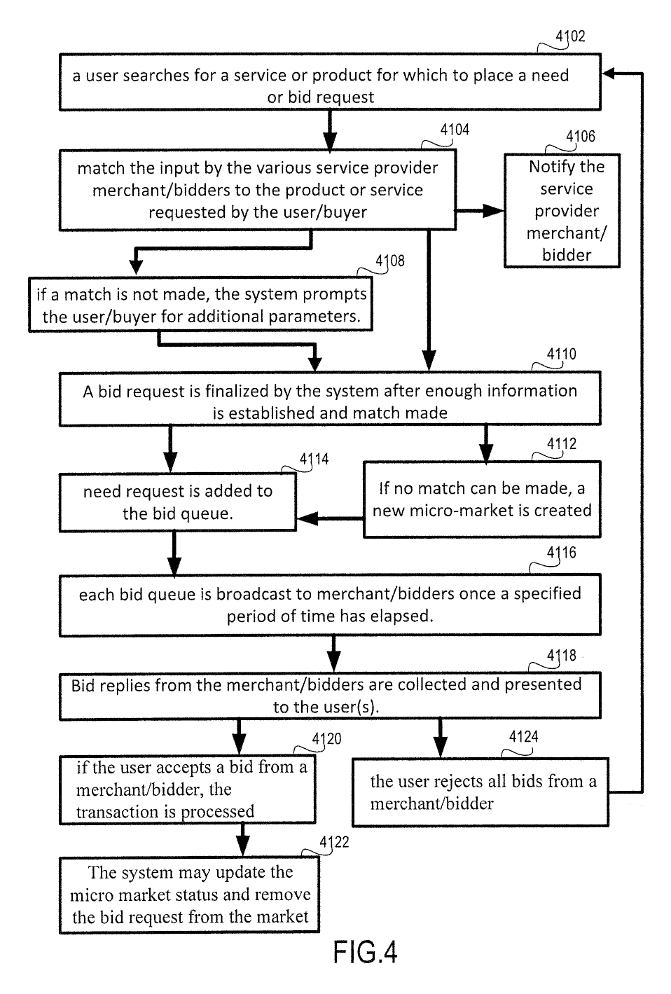

Another example process flow can be found in FIG. 4. In FIG. 4, first a user searches for a service or product for which to place a need or bid request 4102.

Next, the system attempts to match the input by the various service provider merchant/bidders to the product or service requested by the user/buyer 4104.

In some embodiments, the service provider merchant/bidder may be notified 4106.

Next, if a match is not made, that is, if the product or service from the user/buyer bid request does not appear to exist in the system, the system could prompt the user/buyer for additional information or parameters 4108.

A bid request may be finalized by the system after enough information is established and match made 4110.

If no match can be made, a new micro-market may be created and added to the bid queue 4112.

Then, once a match is made between the user/buyer bid request for a product or service and the products/services offered by the merchant/bidders in the micro-market list, that need request may be added to the bid queue 4114.

Next, each bid queue may be broadcast to merchant/bidders once a specified period of time has elapsed 4116.

Bid replies from the merchant/bidders may be collected and presented to the user(s) 4118.

Then, if the user accepts a bid from a particular merchant/bidder, the transaction may be processed as described above 4120.

The system may also update the micro market status and remove the bid request from the market to avoid merchant/bidders from bidding on an already accepted bid request 4122.

If the user/buyer rejects the bid or bids, the user/buyer can either cancel the bid request 4124 or start from the beginning by refining the product details and solicit new bids, or just place the same bid back into the system to solicit new bids 4102.

### Transaction Management

The transfer of money after a bid is accepted by a user/buyer may take place to finalize the transaction. The logistics of transferring the money from the user/buyer to the winning merchant/bidder could take many forms. For example, the system could have its own banking system with cash accounts available to registered user/buyers and also merchant/bidders. In such an example, the system could transfer the money internally after a bid is accepted by a user/buyer. Other examples include the ability for the system to interact with outside banks or financial institutions. In such examples, credit or bank cards could be charged of user/buyers who accept a bid, on behalf of a merchant/bidder. In other examples, the system could coordinate transfer of money in a third party system such as PayPal® or a regular checking account or facilitate the transaction through internet currencies such as Bitcoin. A combination of third party and internal account settlement could be utilized. The system may charge a fee to handle the transactions with the internal accounts, or external accounts or both.

Transaction management functionality may also implement any follow up required to ensure delivery of service or product and user satisfaction, for example through surveys.

### Example Embodiment

### Features

### Example

### Discounts

In certain embodiments, users who desire a repetition of purchases may feel they are deserving of some kind of additional discount. For example, a frequent flyer may feel that multiple purchases of plane tickets to the same destination should garner a cheaper fare. Another example could be a purchaser of bulk items who desires a discount over a purchaser who may buy one or two of that item. Different requests and information could be input into the system to allow for these different arrangements to be made.

Group discounts could be sought by groups of user/buyers with the system facilitating and bringing together user/buyers with similar or the same needs. In this way, a merchant/bidder could view the sale as one bulk sale and only have to distribute separately to individual users.

### Examples

### Auto Bids

Certain embodiments of the methods and systems described herein could include a manual style bid process as well as any number of automated bidding techniques. For example, if a user/buyer posts a need on the system, merchant/bidders could have automated instructions for the system to seek out that particular need and start bidding. Any combination of automatic bids could be programmed by the merchant/bidder. For example, bid ceilings could be installed, early bid requirements to only bid if the merchant/bidder is first or second to respond, no limit bidding could be programmed to ensure the merchant/bidder received the winning bid for a particular user/buyer need, etc.

In another example within a Micro Market, the system may identify a certain hotel chain, or that a user prefers a specific chain. If the system recognizes that the user meets certain criteria, it will offer a pre-loaded deal. In such a way, a static bid may be arranged, as opposed to real-time bidding. Such an arrangement could be for groups of people, could be separated into multiple levels, etc.

### Example

### Sponsored Bids

Certain embodiments of the methods and systems could utilize sponsored bids. In such examples, merchant/bidders would be required to pay the operators of the system in order to submit a bid. Bids could be bundled in packages for convenience and to promote multiple bids. Such merchant/bidders could then expend the purchased bids on user/buyers that they feel may actually accept. This may cut down on the number of unsolicited bid responses, SPAM type responses, or bid responses that are spurious or intended to flood the user/buyers and the market.

In certain example embodiments, user/buyers could be charged for submitting needs for posting. In such a way, the user may pay a premium to receive bids from targeted merchant/bidders and may be allowed to view many options from which to choose, depending on how many merchant bids are submitted. In certain example embodiments, user/buyers could pay more of a premium to see more bids. Certain examples include the ability for the system to help a user/buyer prepare a need request by assigning a personalized assistant, provide tips or suggest previously successful verbiage and tactics to use in a successful need request. Such services could be provided to user/buyers at a premium.

### Example

### Notifying

In certain example embodiments, the system could be arranged to notify a merchant/bidder of a particular post by a user/buyer. Such notification could be by email, text message, phone call, internal messaging and notification system, instant message, or any other kind of way. Such a notification, or alert, could trigger a merchant/bidder to prepare for bidding. Such an alert could trigger the merchant/bidder to institute an automatic bid program for that particular need.

The merchant/bidder could provide the system with any number of criteria for posts that it wishes to be alerted to. This could include any number of categories, descriptive words, geographical location criteria, demographic criteria, or any other kind of criteria. In this way, a merchant/bidder could help ensure that only tailored and desirable posts are communicated.

### Example

### Rating System

In certain example embodiments, a user rating system could be implemented. Such a system could help other and/or future users in evaluating a product or service offered by a merchant/bidder. Thus, using collective crowd sourced knowledge, the market could gain insights into particular merchant/bidders and inform user/buyers about them.

The interface allowing ratings of merchants could range from any kind of comment system to a number system to a star ranking system, etc. The ratings and/or comments could be available to user/buyers by text searching, number, symbol, category, etc. A user/buyer could look up a particular merchant/bidder to see what past users have experienced. User/buyers could be prompted by the system at different stages of the process for feedback. For example, after the need has been fulfilled by the merchant/bidder, the system could send an email or text or other communication survey or prompt to rate the merchant/buyer. In this way, merchant/bidders would have incentive to be honest as their online reputation could help them with business.

It should be noted that a similar rating system could be used for merchant/bidders regarding user/buyers. In such examples, merchant/bidders could inform other merchant/bidders as to which users may fulfill purchases in a timely manner, and which are harder to work with etc.

### Mobility Examples

In certain example embodiments, the services described herein may be offered via an application on a mobile device. Such devices could utilize their internal location features in order to direct which merchant/bidders may bid on their needs. Thus, the system could direct only certain needs to merchant/bidders if the location of the need is important, for example, a locally requested product or service. A user in need of house cleaning, for example, would not want a bid from across the country, but would only want bids from house cleaning companies nearby. Any kind of range limit, geographical or boundary arrangement could be made in order to make the bids more relevant.

Additionally, in a mobile device example, the systems and methods described herein may centralize and/or decentralize the storage and bidding processes. In a centralized example, the back end servers could do most of the computing, matching, analysis, etc. and allow the mobile application to avoid much computational burden. Rather, the back end systems could simply push and pull information to and from the mobile application and avoid the user's device from having to perform such functions and processing. By removing processing from the user's device, the user can more quickly view information without depleting the device's battery life and other resources, thereby improving the overall operation, speed and efficiency of the user's device.

As disclosed herein, features consistent with the present disclosure may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the present disclosure or they may include a special-purpose computer or computing platform selectively activated or configured by code to provide the necessary specialized functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of this disclosure, or it may be more convenient to construct a specialized apparatus or system to perform the required methods and techniques.

Aspects of the methods and systems described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as 1PROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of this disclosure have been specifically described herein, it will be apparent to those skilled in the art to which the disclosure pertains that variations and modifications of the various implementations shown and described herein may be made without departing from the spirit and scope of the disclosure. Accordingly, it is intended that the disclosure be limited only to the extent required by the applicable rules of law.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

What is claimed is:

1. A method for conducting computer network transactions, comprising:
at a server computer in communication with a network and a database,
receiving merchant information from merchant/bidders via the network;
categorizing the received merchant information;
storing the merchant information and the associated category in the database;
receiving a need from a user/buyer computer via the network;
identifying a category that the received need fits based on the categories of merchant information;
if the received need matches a merchant category,
posting the received need information so the merchants identified for that category may access the posted need information;
if the received need does not match a merchant category,
requesting more information from the user/buyer via the network until a category is matched; and
posting the received need information so the merchant/bidders identified for that category may access the posted need information;
receiving bids from the merchant/bidders on the received need;
submitting the received bids from the merchant/bidders to the user/buyer;
receiving from the user/buyer a selection of a submitted bid from the merchant/bidders; and
removing the posted received need information to close bidding, so no more merchant/bidders may access the need and submit bids.

2. The method of claim 1, wherein receiving from the user/buyer the selection of the submitted bid is based on an arranged set of acceptance criteria sent by the user/buyer and stored by the server computer in the database.

3. The method of claim 1, wherein the server computer further comprises a micro market system interface which allows the merchant/bidders to review submitted need information via the network.

4. The method of claim 1, further comprising,
notifying the merchant/bidders of received needs that match the stored merchant information category.

5. The method of claim 1, wherein if the received need does not match the merchant category, the method further comprises:
creating a new category; and
posting the received need information so that merchants associated with the new category may access the received need information.

6. The method of claim 1, further comprising establishing a time limit during which bids from the merchant/bidders on the need are received.

7. The method of claim 1, wherein the receiving merchant information from merchant/bidders via the network, further comprises receiving an indication of the category from the merchant/bidder via the network.

8. The method of claim 1, wherein the identifying the category that the received need fits into comprises receiving an indication of the category from the user/buyer via the network.

9. The method of claim 1, further comprising:
after submitting the received bids from the merchant/bidders to the user/buyer, re-posting the received need from the user/buyer computer if no selection of the submitted bid from the merchant/bidders is received.

10. The method of claim 1, further comprising:
receiving, from the user/buyer computer via the network, a rating of the merchant/bidder selected by the user/buyer; and
posting the rating of the merchant/bidder via the network so that other user/buyers are able view the rating of the selected merchant/bidder.

11. A system for conducting computer network transactions, comprising:
a server computer in communication with a network and a database, the server computer executing computer-executable instructions that cause the server computer to:
receive merchant information from merchant/bidders via the network;
categorize the received merchant information;
store the merchant information and the associated categories in the database;
receive a need from a user/buyer computer via the network;
identify the category that the received need fits into based on the categories of merchant information;
if the received need matches a merchant category,
post the received need so that the merchants identified for that category may access the posted need,
if the received need does not match a merchant category,
request more information from the user/buyer computer via the network until a category is matched, and
post the received need information so the merchant/bidders identified for the category may access the posted need information;
receive bids from the merchant/bidders on the received need;
submit the received bids from the merchant/bidders to the user/buyer computer;
receive from the user/buyer computer a selection of a submitted bid from the merchant/bidders; and
remove the posted received need information to close bidding, so no more merchant/bidders may access the information and submit bids.

12. The system of claim 11, wherein the selection of the submitted bid received from the user/buyer computer is based on an arranged set of acceptance criteria sent by the user/buyer computer and stored by the server computer in the database.

13. The system of claim 11 further comprising a micro market system interface which allows the merchant/bidders to review submitted need information via the network.

14. The system of claim 11, wherein the server computer is further configured to notify the merchant/bidders of received needs that match at least one of the stored received merchant information categories.

15. The system of claim 11, wherein the server computer is further configured to:
create a new category; and
post the received need so the merchants associated with the new category have access to the received need.

16. The system of claim 11, wherein the server computer is further configured to limit the time during which the merchant/bidders are able to bid on the received need.

17. The system of claim 11, wherein the server computer is further configured to receive an indication of the category from the merchant/bidder via the network.

18. The system of claim 11, wherein the server computer if further configured to:
receive, from the user/buyer computer via the network, a rating of the merchant/bidder selected by the user/buyer; and
post the rating of the merchant/bidder via the network so other user/buyers are able to view the rating of the selected merchant/bidder.

19. A system for conducting computer network transactions, comprising:
at a server computer in communication with a network and a database,
receiving merchant information via the network;
storing the merchant information and one or more associated categories in the database;
receiving a need from a user/buyer computer via the network;
posting the received need so that merchants are able to access the posted need;
receiving bids from the merchants for the received need;
submitting the received bids from the merchants to the user/buyer computer; and
receiving a selection of at least one bid submitted by the merchant/bidders.

20. The system of claim 19 further comprising,
receiving, from the user/buyer computer via the network, a rating of the merchant/bidder selected by the user/buyer; and
posting the rating of the merchant/bidder via the network so other user/buyers may view the rating of the selected merchant/bidder.
